(19) United States
(12) Patent Application Publication
(10) Pub. No.: US 2006/0143108 A1
(43) Pub. Date: Jun. 29, 2006

(54) Negotiation system

(76) Inventors: Simon G Thompson, Ipswich (GB); Lyndon C Lee, Ipswich (GB); Roberto Avalos Salas, Tulanchigo (MX)

Correspondence Address: NIXON & VANDERHYE, PC, 901 NORTH GLEBE ROAD, 11TH FLOOR, ARLINGTON, VA, 22203, US

(21) Appl. No.: 10/560,615

(22) PCT Filed: Jul. 23, 2004
(86) PCT No.: PCT/GB04/03251

§ 371 Date: Dec. 14, 2005

(30) Foreign Application Priority Data
Jul. 25, 2003 (GB) 0317469.5

(51) Int. Cl. G06Q 40/00

(52) U.S. Cl. 705/37

(57) ABSTRACT

Negotiations for internet-based auctions or other bidding processes use a plurality of computer-based agent means 21,23,24. An originating agent 21 first defines the rules of the session by retrieving from a store 22 a previously-generated definition of the interactions required in a negotiation, and the purpose of each interaction, and a program for running a process that meets this definition. Having generated the rules under which the negotiations will be undertaken, the originating agent 21 transmits these details to the repository 22 (step 30) where they can be accessed by other users 23. These users follow the rules and the matrix of the session, and each generates a new matrix which is evaluated by the initiator 21 which then generates a selection from alternative matrices offered by the respondents 23. This process continues through a sequence of one or more negotiation phases with natural or artificial terminating conditions, when either a predetermined pattern of messages has been executed (or some other condition of the negotiation rule is achieved) or when an agreement has been made. The negotiation process is defined in terms of a predetermined plurality of phases during which particular parts of the negotiation are completed, responses to requests in an earlier phase in the process constrain the responses generated in subsequent phases, and the respondents can constrain their responses to one phase according to the known rules of the phases still to come.

This invention relates to apparatus and processes for supporting business negotiations for procurement of commodities and services, and in particular the use of electronic agents to describe and offer commodities and services to one another. In this specification, commodities and services will collectively be referred to as “products”. Hitherto, two approaches have been followed in this area. The Web Services Interoperability organisation (WS-I) have proposed a common web service profile language which describes the service in terms of how to invoke it, whilst the Defence Advanced Research Projects Agency (DARPA)Web Service group have developed an XML based service description language known as DAML-S, which describes the service in terms of what it does. DAML-S does not have a descriptive ontology for interactions, but does have a process model which can be used to explicitly describe protocols. This is described by Ankolekar et al in the Proceedings of First International Conference on the Semantic Web, Sardina, Italy. Jun. 9^{th}-12^{th}, 2002

Bartolini et al of the University of Southampton (Proc. 3rd International Workshop on Agent-Oriented Software Processing, Bologna, Italy, 87-98 (2002)) describe an ontology for negotiation. Tamma et al, of the University of Liverpool (Proceedings of the Workshop on Ontologies in Agent Systems, Bologna, Italy, July 2002) describe a similar system, but there is a difference in that the object of the negotiation is discussed.

U.S. Pat. No. 6,347,307 describes a system in which a taxonomy/ontology (FinXML) specifies interactions such as “spot”, and “InterestRateFixedFloatSwap”.

According to the present invention, there is provided apparatus for supporting negotiations comprising a group of agent means, wherein at least one of the agent means comprises means for initiating interactions between the agent means, and means for defining the negotiation in terms of one or more phases during which particular parts of the negotiation are completed, such that the responses to requests in an earlier phase in the process constrain the responses generated in subsequent phases, and wherein each agent means has means for dynamically negotiating an agreement in accordance with the said definition.

The present invention also provides a method for performing negotiations using a plurality of computer-based agent means, wherein one of the agent means initiates interactions between the agent means, and the agent means dynamically negotiate an agreement, and the negotiation process is defined in terms of one or more phases during which particular parts of the negotiation are completed, such that the responses to requests in an earlier phase in the process constrain the responses generated in subsequent phases.

The present invention also extends to a computer program or suite of computer programs for use with one or more computers comprising a set of instructions to carry out the method of the invention or to provide the apparatus.

The invention allows the negotiation process to be opened, interpreted and executed as a number of phases, the outcome of each phase being used to infer the possible set of states at subsequent phases. The availability of options for decisions during each phase of the negotiation may be constrained relative to the possible states of the overall negotiation. Because the rules of subsequent phases can be retrieved, agents following these rules can therefore use the constraints that will be imposed in the later phases of the negotiation to determine their actions in the early phases of the negotiation. For example they can use a constraint on the price which is to be negotiated later to determine the bid ranges they should operate in for an early quality phase.

The “product” referred to above may be any outcome desired by the originator of the request, such as the supply of a physical commodity or service, or a more abstract outcome such as a financial transaction or a computation. The invention can be used in a one-to-many situation (where there is more than one potential supplier of the product), or a many-to-one situation where there is more than one potential customer for a single supplier. The process may also be extended to a many-to-many situation.

In contrast to the prior art systems, the present invention uses a componentized characterization of the description of the interaction rules between the participants in the negotiation, which differs from the prior art systems discussed above in that the phases of negotiation are decomposed more fully. The process places more emphasis on lifecycle rules, describes transitions in the negotiation process instead of just termination rules, and imposes constraints between the phases of the negotiation. Instead of attempting to handle all the constraints together, the process handles them stepwise. Thus at each phase the number of dimensions of the search space to be evaluated by a participant deciding on the optimal response, and the range of possible solutions, strategies and decisions within those dimensions, are smaller than in the prior art single phase systems.

By operating as a sequential process, the various elements of the finally negotiated result can each be handled rigorously, and without the need for predetermined weightings for each relevant factor to be applied by each agent. The invention also allows the process to be simplified as some agents may be able to be eliminated before the process is complete.

This process more closely follows the behaviours expected of human participants in an auction process, in which possible outcomes are first identified and more detailed negotiation is then limited to those possibilities. The invention is therefore arranged to interpret these descriptions and act on them. In particular the descriptions of the process are in terms of the phases of activity in an interaction. For example, using the present invention it is possible to specify a pre-qualification phase, a phase in which the characteristics of the commodity are negotiated and a phase in which the price of the commodity is negotiated. The outcomes of the phases of the negotiation can be tied together in a way that can be interpreted by a program; it is possible to specify a concept like “the price agreed in a given phase will be the only price that will be legal in subsequent phases”. This is significant because it constrains the size of the space that agents must reason over when composing bids at each phase. A constraint specified for an earlier phase may therefore be used to constrain the reasoning to be used in a later phase. A constraint can also be used in reasoning of phases previous to the one in which the constraint will appear. For example, agents that interpret the service description will be able to determine that, if price will be constrained in a subsequent phase, other considerations the subject of the current phase (quality, time of delivery, support and servicing) must be subordinate to the price at which the product can be offered.

The invention may be implemented in a peer-to-peer fashion, the necessary processing programming being downloaded to potential users. It could also be implemented over fixed servers, in which a server having the necessary software acts as the end user's agent.

An embodiment of the invention will now be described, by way of example only, with reference to the drawings, in which:

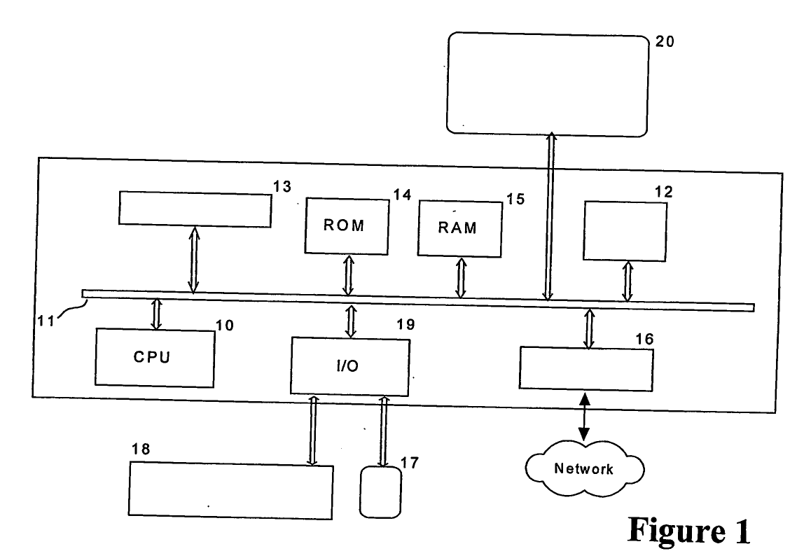

FIG. 1 shows the components of a typical general-purpose computer suitable for performing the invention.

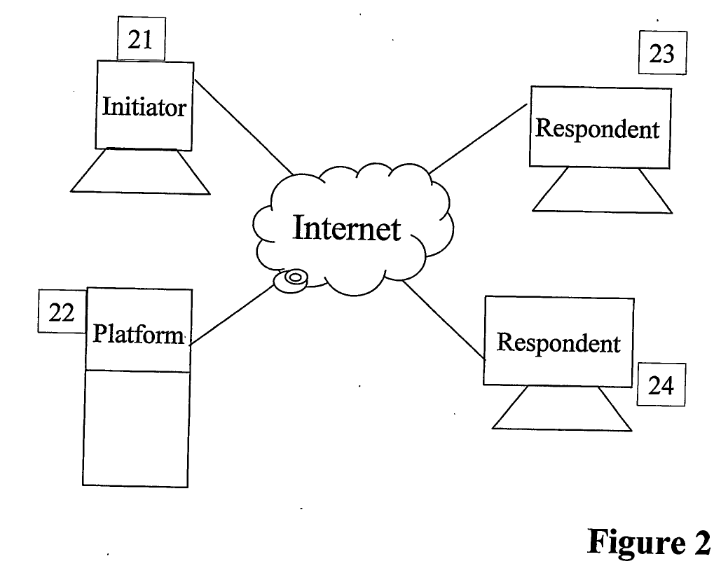

FIG. 2 illustrates the functional programme elements that interact to perform the process of the invention

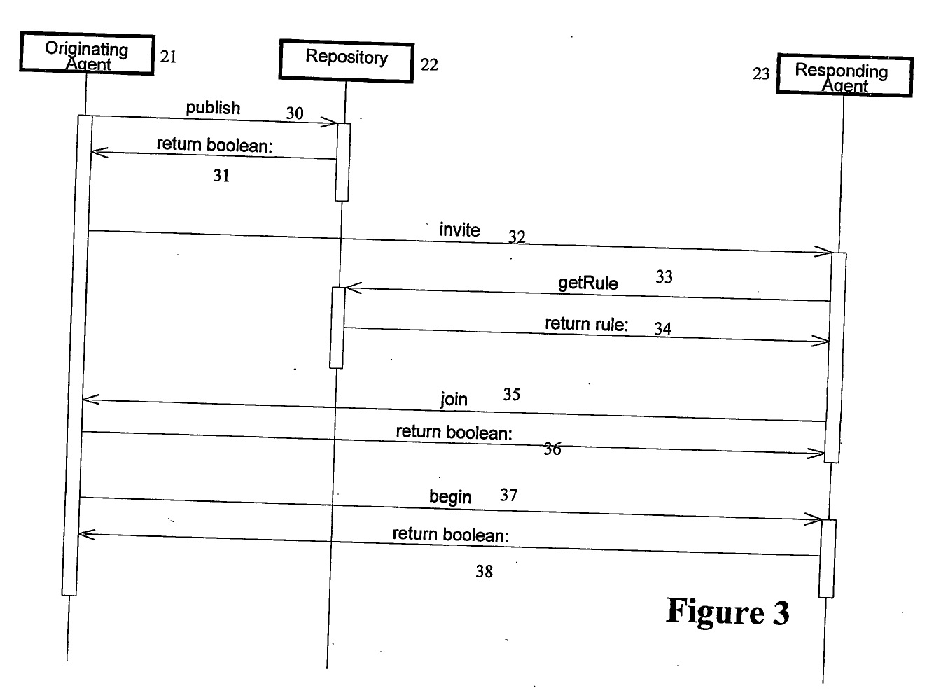

FIG. 3 is a flow chart illustrating the initial stages of the process of the invention.

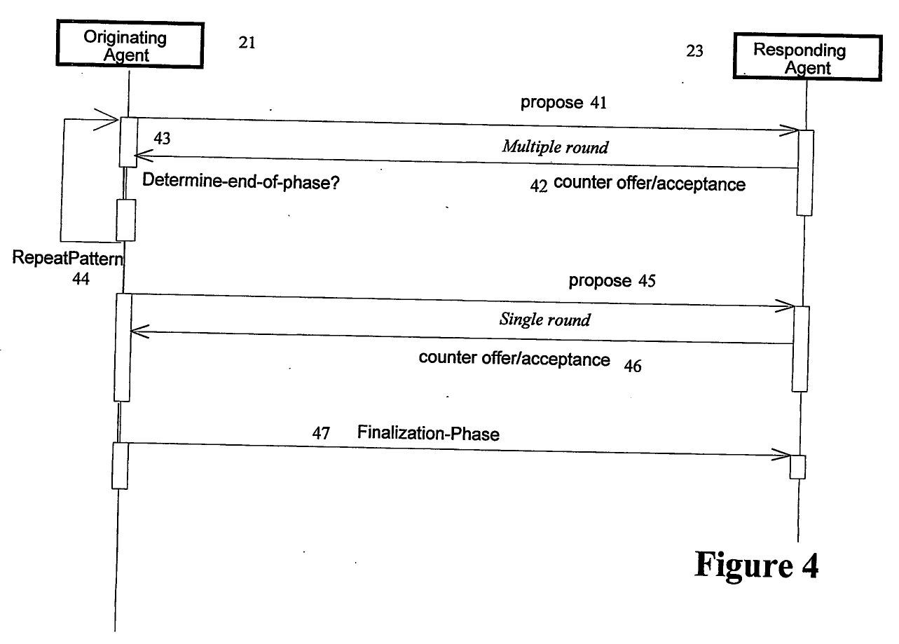

FIG. 4 is a flow chart illustrating the subsequent stages of the process of the invention.

A typical architecture for each of the computers 21, 23 . . . on which software implementing the invention can be run, is shown in FIG. 1. Each computer comprises a central processing unit (CPU) 10 for executing computer programs and managing and controlling the operation of the computer. The CPU 10 is connected to a number of devices by way of a bus line 11, the devices including a first storage device 12, for example a hard disk drive for storing system and application software, a second storage device 13 such as a floppy disk drive or CD/DVD drive for reading data from and/or writing data to a removable storage medium and memory devices including ROM 14 and RAM 15. The computer further includes a network card 16 for interfacing to a network. The computer can also include user input/output devices such as a mouse 17 and keyboard 18 connected to the bus 11 via an input/output port 19, as well as a display 20. It will be understood by the skilled person that the above described architecture is not limiting, but is merely an example of a typical computer architecture. It will be further understood that the described computer has all the necessary operating system and application software to enable it to fulfil its purpose.

The invention is preferably implemented as an agent-based application, with the negotiation session controlled from a negotiation platform 22. In general the negotiation platform and the individual agents 21, 23, 24 . . . would each be hosted on different computers such as that shown in FIG. 1, communicating with each other, through their input/output ports 19, using protocols such as the standard internet protocol or the XML “Web Service” standard through a distributed computing network such as the public “Internet”, a private “intranet”, the supercomputing network known as “the GRID”, or some other communications medium. However, one or more of the agents 21, 23, 24 . . . may be hosted on the same hardware as the negotiation platform 22.

The process is illustrated in FIGS. 3 and 4. In each negotiation session, the entity under negotiation is represented by a negotiation matrix, describing the details of that entity. A session normally consists of one initiator and one or more respondents. An initiator 21 is the entity (user and software) that initiates a negotiation session. For simplicity only one respondent 23 is shown in FIGS. 3 and 4, but it will be understood that the initiator 21 corresponds in a similar manner with each respondent.

The originating agent 21 first defines the rules and the matrix of the session. The originating agent 21 begins this process by retrieving from the store 22 a previously-generated definition of the interactions required in a negotiation, and the purpose of each interaction. It also retrieves a process that meets this definition. The process by which this data is generated for subsequent retrieval will be discussed later. The definition retrieved by the originating agent defines the negotiation process to be followed in terms of a negotiation rule, which specifies the individual phases and the transitions between them, and a negotiation matrix, which defines the item under negotiation. The negotiation rule refers to the state of the negotiation matrix at the current phase of the auction, thus defining the purpose of that phase of the interaction in terms of the previous phase and the next phase.

The program retrieved from the store interprets the rule in two ways. Firstly the program contains instructions as to how the agent should generate messages and responses at a given phase in the interaction. Secondly, itsets bounds on the bids that the agent should evaluate for utility at this phase of the interaction. Bids can be considered mathematically to be sets of curves, (or sets of points if the solutions are constrained to take discrete values), representing the conditions that agents are prepared to declare as being possible at the current phase of the interaction.

The interaction with the responding agents is shown in FIGS. 3 and 4. Having generated the rules under which the negotiations will be undertaken, the originating agent 21 transmits these details to the repository 22 (step 30) where they can be accessed by other users 23 etc.

Having received confirmation that publication has been successful (step 31) the originator 21 then opens a negotiation session (step 32) by issuing invitations to potential respondents 23, etc. This may be done in a number of ways. For example, agents may have advertised that they are interested in participating in interactions in a directory that is accessible to the originating agent, and the originating agent then contacts them when it is ready with invitations. Alternatively, the prospective respondents may send subscriptions to originating agents that have advertised in a directory, which then send invitation messages to them when it is ready. Agents may also advertise interactions becoming available, together with information about them (how to join and the rule) in an accessible directory, and prospective respondents poll the directory to find interactions that are of interest to them. The accessible directory can be a single central file store like UDDI 2.0 or Google, or a federated store like a FIPA DF or the proposed UDDI 4.0. Alternatively a peer to peer arrangement may be used, in which the agents form a federated network and respond to information queries by saying what they know and asking all their contacts about it.

The entities 23 interested in responding to the invitation 32 next request the rules from the repository 22 (step 33) which are returned (step 34) to the responding entity.

Those entities 23 that desire to join the auction return a “request to join” (step 35) which is acknowledged if the request is valid (step 36). These entities 23 are then constrained to follow the rules and the matrix of the session.

When a predetermined condition is attained, such as a time or number of participants, the initiating agent 21 transmits a start signal 37 to all the participants 23,24 that have been accepted (step 36) to participate, and this is acknowledged (step 38). The participants can drop out from the session at any time, and may rejoin later if the initiator 21 allows them to do so.

The initiator 21 then generates a selection from alternative matrices offered by the respondents 23. This process is responsible for evaluating alternatives, and either makes a valid selection from the available alternatives or generates a new matrix to refine the negotiation process.

The negotiation process itself is shown in FIG. 4, which is a continuation of FIG. 3 and consists of a sequence of one or more negotiation phases with natural or artificial terminating conditions. Each phase consists of an exchange of messages known as “speech acts” that are tagged with a declaration of intent (ask, tell, bid, query, propose . . . ) that instructs the receiver that the message should be interpreted in a particular way. (Only the phase-originating speech act—the first message at a phase—and the finish of each phase is shown explicitly in FIG. 4). Alternatively, a procedure call interface could be used.

Navigation between phases occurs when either a predetermined pattern of messages has been executed (or some other condition of the negotiation rule is achieved) or when an agreement has been made. Negotiation rules are used to define the number and the property of each negotiation phase, the terminating conditions, and deal determination.

Each phase in a negotiation session has one of the three dialogical properties: single round, double round or multiple round. In a multiple round phase (steps 41, 42, 43, 44) a proposal (41) is made and a response is returned (42) this response is then evaluated (step 43) and if it determines that the exit criteria have been met the process proceeds to the next phase (step 45). Otherwise a new counterproposal is generated (step 44) and the phase is repeated (41, 42).

Some phases may take a predetermined number of rounds. In a single round phase (45, 46), there is just one exchange of messages (propose 45: accept/reject 46)). In a double round phase (not shown in FIG. 4) there are three steps: (propose: counterpropose: accept/reject)

FIG. 4 is merely illustrative. Of course, there may be more than the three phases shown in FIG. 4, and each phase may have any of the three dialogical properties discussed above.

The terminating conditions are controlled by further properties, such as an upper limit on the number of iterations (MAX_ROUND), or a time out condition.

Upon a valid selection, the last phase begins a final step 47 that automatically invokes finalisation and rejection procedure. There may be further final phase processes, such as calculation of tax or service provider's commission, which may vary depending on the successful bidder in the negotiation, but are not relevant during the negotiation. Moreover, there may be a requirement for additional functions. For example where an order is being placed against a specification (for example a new car to be built to order) its production has to be arranged. Where the order is for an identified specimen (for example a second-hand car) inspection may be required before the order can be completed. Other factors such as delivery arrangements may also be necessary.

Once the final negotiation phase has been processed, a further set of rules determines the final price of the deal, and any matching algorithms to handle lot allocations and price determination. There is then a finalisation process where both consenting parties regard the negotiation session as ended with a mutually agreed obligation. The session is then terminated.

If appropriate, for example in the event that none of the respondents have been able to meet the conditions specified in the session, the initiator 21 may instead run a rejection process to inform all the respondents that the negotiation session has been terminated.

The platform 22 may be instructed to navigate non-sequentially to any negotiation phase. The initiator 21 can also alter the negotiation rules at run time. The platform 22 provides a default evaluation according to the Pareto optimisation process. This process generates a matrix which produces the optimum overall score. The implication is that if any alternative matrix would be better, for all participants, than the one generated by the decision making process, this alternative will be selected automatically In other words, the decision making process cannot generate a request matrix that is sub-optimal to an offered matrix if such alternatives would not be acceptable to one or other party. To override this behaviour, the decision-making process must be capable of overriding the transition process selected by the program The decision-making process adheres to a defined programmatic interface [AgentFunction]. The decision making process can rewrite itself at run time; or it can register another decision-making process program for a negotiation phase. The platform uses an adaptive loader program, which imports the program code that it runs to make a decision as it runs and updates it regularly during running. Code is loaded at every discrete time of the negotiation session.

In the decision making process, the interface is implemented in the form of a function called “method” with a parameter of type “decision (number)”, where “number” is the numeric equivalence to the sequence number of the negotiation phase. Note that the numbering starts from “0”. A default function method [generalDecision) is implemented when a specific function is not provided by the implementing programmer. That is to say, if the platform attempts to invoke a function that has not been programmed into the system, then the platform will attempt to invoke the default [generalDecision] instead.

The program data to be used in the process may be generated using the following steps.

Definition step: preparation of a set of evaluation functions and a set of sequent rules. These are placed in the interpretation store

Intialisation step: Definition of the rule of the negotiation (number of phases, message rules per sequence, good at sequence, timings/exit/entry criteria) and publication to the advertising directory. The initiator constructs the rule from its interpretation store, either due to a program or due to rules defined by a programmer that act over the initiator's current perceived requirements

First negotiation phase: the participants find the declaration and load the rule from the advertising directory. They use the rule for all phases of the negotiation as input to evaluate the bids that they should make in phase 1.

Subsequent negotiation phases: When the exit criteria for the previous phase has been reached all participants move to the next phase. They continue to bid as before, but their evaluations are further constrained by the outcomes of the previous phases, in addition to the constraints described for this phase and phases to come.

Final negotiation phase: during the final phase bids are evaluated using only the final phase's constraints and the outcomes of all previous phases.

These steps will now be described in more detail. There is first an initialisation step
NegotiationProcess eng=new NegotiationProcess(temp,nameservers);

A process is then called to set up any necessary GUI that is required, different processes may provide different GUIs
eng.setStandardGUI(true);

The session is then created, and its type defined. The contract net message sequence rules are retrieved from the data store

Negotiation neg=eng.createNegotiation( );

neg.setNegotiationType(Negotiation.CONTRACT_NET);

Next the names are set for the functions that are to be called at each phase of the negotiation process

neg.cs.programs=new String[neg.cs.states.length];

for (int j=0; j<neg.cs.states.length; j++)

if ( j == 1 )

neg.cs.programs[j] = “program1”;

else

neg.cs.programs[j] = “program02”;

(Program 1 and program 2 are decision procedures that are retrieved for particular phases.)

The parameters of the negotiation rule/matrix for declaration are now set neg.setNegotiationDetails(“bid”, 1, 100, “something”, “no desc”);
These terms parameterise the retrieved decision functions

The negotiation process is now begun

eng.startNegotiate(neg);

When a new proposal (i.e. negotiation matrix) is received by a user agent 23, the add(Performative) method in Process will be invoked by the recipient 23. This method needs to be adapted to the requirements of the individual agent's programs, so that the agent will invoke the program. Thus the rule is retrieved from the return message 34. For example:

YourProgram you = new YourProgram(.); // or register

yourself with the CoordinationState
you.newMatrix(cs); //
cs is the CoorStruct extracted from the performative.

Then the required data structures are set up:

String key = context.whoami( ) + “_” + context.newId( ); // or

any unique string

CoorStruct newcs = new CoorStruct(cs); // make a copy

newcs.key = key;

newcs.phaseID = “N10”;

newcs.bidNo = “1”;

newcs.programs = new String[cs.states.length];

A value rs,tran is set to 1 for a bid, otherwise 2
// must be respondent

newcs.xml.priceD = (cs.tran.equals(“bid”)? 1: 2);

The actions for the evaluation states for all steps to programA are set, and the response engine is set to use this
for (int i=0; i<newcs.states.length; i++) newcs.programs[i]=“programA”;
CoordinationState.Process( ).response(newcs);

In order to navigate around the negotiation phases in the decision making process, for example, a routine is created

public void decision2( ) {

if ( round < 10 ) {

jumpto(0); // go back to phase 0

cs.xml.price = “10”; // any my price will be ...
return;

}

...
}

The current platform implementation makes use of the “price” attribute to demonstrate how a decision can be made. It can be replaced by an XML representation (be it a XML document, object or whatever) where a richer set of attributes is required to form the negotiation matrix. As an example,

public void decision3( ) {

if ( round < 10 || time > 12 ) {

cs.xml.attributeA = “I want this”;
cs.xml.attributeB = “I want this too”;
...
return;

}

...
}

The platform provides several interactive facilities and controls for quick testing and manipulation.

public void decision0( ) {

...
if ( cs.xml.price > 100 ) { // assuming it is numeric

prompt(cs.xml.price);
...
return;

}

...
}

The above will invoke a time-countdown window showing basic information about all the alternatives, and the price the decision making process has just computed, and ask the user for further instruction.

public void decision0( ) {

...
if ( time > 100 ) { // assuming the scale is meaningful

quit( );
...
return;

}

...
}

The entity will then terminate or drop out from the negotiation session.

The platform is a “peer-to-peer” decentralized implementation, although it could make use of static directories and repositories or platforms. Although there is no persistent entity in the system that can act as a central authority or broker in any high level sense to hold the “market rules and information”, a limited form of many-to-many negotiation can be supported. Such negotiations can be considered a “market”, that is to say, an institution that allows multiple identical negotiation sessions and has a long life in comparison with the durations of individual sessions. During any negotiation process, a software entity can request to join as a further initiator for that session. The original initiator can, of course, reject any such request.

The process could be extended to a many-many situation. The process would be continuous, and the participants would all advertise their participation through a publicly advertised known contact point. A ACID transaction mechanism could be used to underpin the system to prevent double commitment, although some protocols such as contract nets specifically impose risk on the bidding agents—forcing rational agents to bid lower to account for the risk of an unwanted purchase. Participation and drop out, would be possible ad hoc. As will be understood by those skilled in the art, any or all of the software used to implement the invention can be embodied on any suitable transmission and/or storage medium using any suitable carrier readable by a suitable computer input device, such as CD-ROM, optically readable marks, magnetic media, punched card or tape, or on an electromagnetic or optical signal, so that the program can be loaded onto one or more general purpose computers, or downloaded over a computer network using a suitable transmission medium.

1. Apparatus for supporting negotiations comprising a group of agent means, wherein at least one of the agent means comprises means for initiating interactions between the agent means, and means for defining the negotiation in terms of a plurality of phases during which particular parts of the negotiation are completed, such that the responses to requests in an earlier phase in the process constrain the responses generated in subsequent phases, and wherein each agent means has means for dynamically negotiating an agreement in accordance with the said definition.

2. Apparatus according to claim 1 such that the space of options for decisions during each phase of the negotiation that each agent has to make is constrained relative to the possible states of the overall negotiation.

3. Apparatus according to claim 1, comprising means for the generation of a description of the interactions required in a negotiation, and the purpose of each interaction, and means for the retrieval from a store of a process that can act on these descriptions.

4. A method for performing negotiations using a plurality of computer-based agent means, wherein one of the agent means initiates interactions between the agent means, the agent means dynamically negotiate an agreement, and the negotiation process is defined in terms of a plurality of phases during which particular parts of the negotiation are completed, such that the responses to requests in an earlier phase in the process constrain the responses generated in subsequent phases.

5. A method according to claim 4 in which the availability of options for decisions during each phase of the negotiation is constrained relative to the possible states of the overall negotiation.

6. A method according to claim 4, comprising the phases of
generation of a description of the interactions required in a negotiation, and the purpose of each interaction, and
retrieval from a store of a process that can act on these descriptions.

7. A computer program or suite of computer programs for use with one or more computers comprising a set of instructions to carry out the method as set out in claim 4.
